(19) United States
(12) Patent Application Publication
(10) Pub. No.: US 2005/0224193 A1
(43) Pub. Date: Oct. 13, 2005

(54) Hydraulic lifting sectional security door

(76) Inventor: Giampaolo Nelzi, Appiano Gentile-Como (IT)

Correspondence Address: HEDMAN & COSTIGAN P.C., 1185 AVENUE OF THE AMERICAS, NEW YORK, NY, 10036, US

(21) Appl. No.: 10/507,087

(22) PCT Filed: Mar. 6, 2003
(86) PCT No.: PCT/EP03/02305

§ 371 Date: May 18, 2005

(30) Foreign Application Priority Data
Mar. 8, 2002 (IT) MI2002A 000497

(51) Int. Cl. E05F 15/08

(52) U.S. Cl. 160/188

(57) ABSTRACT

An improved hydraulic lifting sectional security door, capable of being installed at an entry space to a room, comprising a pair of profiles (PRF) near to each frame (STP) of the entry space, a series of panels (PNL) articulated together and a device or group (GP) for lifting the panels (PNL), which includes a hydraulic cylinder (CI), to which fixed and mobile lifting pulleys (PL1, PL2, PL3, PL4) are fixed; according to the invention the lifting cables (FA1, FA2) start from stops (FE1, FE2), which are preferably next to the cylinder (CI) and their exit in the direction of the return pulleys (PU1, PU2) takes place in a balanced manner, on the two outer sides of the lifting pulleys (PL1, PL2, PL3, PL4), so as to be able to obtain a reversible container (CAS), which allows the hydraulic cylinder (CI) and the exit of the hydraulic tube (TU) to the right or left of the entry space, according to the user's desires and requirements.

The present invention refers to an improved hydraulic lifting sectional security door.

Sectional doors, doors formed from horizontal sections of simple or insulated panels, joined together by hinges, are known, which are equipped on the outside with caster wheels suitable for engaging and rotating in side rails, so as to keep the sections of the panels guided and joined together sliding upwards to open.

These doors generally foresee three types of installation:
standard, for low ceilings, according to which the panels rotate horizontally just above the entry space to the room;
vertical, in which the panels slide completely vertically; and
lifted horizontal, for which the panels rotate horizontally to a certain height above the entry space to the room.

Sectional doors can be opened and closed by hand, thanks to the moving of a pack of torsion springs, which pulls two side drums into rotation, on which two metal cables are wound which hook on the last lower panel.

Alternatively, according to more recent embodiments, the group for lifting the sectional door essentially consists of a hydraulic cylinder actuated by a plurality of lifting and return pulleys and arranged in a protection and guide seat. The extension of the hydraulic cylinder caused by the introduction of pressurised oil allows a lifting system perfectly parallel to the door to be obtained.

Such a system allows panels even of substantially varying weights to be realised, allowing, for example, reinforcements to be applied on the lower panels, which are subject to frequent knocks and damage.

Moreover, the system ensures greater freedom of application, less productive constraints and almost zero maintenance costs with respect to conventional spring lifting systems.

Nevertheless, hydraulic lifting systems also have some drawbacks and limitations.

First of all, the container containing the hydraulic motorisation, since it is not reversible, must always be constructed with the right or left cylinder of the entry space to the room, such that it is necessary to construct the motorisation to size, after having accurately defined whether the hydraulic tube must come out to the right or left, according to the positioning of the electrohydraulic unit.

Indeed, the hydraulic tube cannot, in this case, simply be upturned inside the container, due to the risk of contact of the tube with the pulleys in motion and since the radius of curvature is too tight. Moreover, the tube upturned on the outside, besides having higher costs, is not aesthetically pleasing.

Moreover the container containing the motorisation must be constructed to size for each sectional door and does not foresee characteristics of adaptability, even to a small degree, to possible errors which can be committed in the construction of the entry space to the room.

Precisely the non-complete adaptability of the container at the specific time when needed determines the fact that retailers are unable to buy it as stock in hand.

Furthermore, in conventional hydraulic lifting systems, in consideration of the fact that the cables depart one from inside the tackle clearance and the other outside, it may be that the actuator cylinder extends with lateral flexion of its stem, emphasised above all in heavier doors, due to the winding of the two lifting cables with the tackle unbalanced. All of this is so since the thrust on the stem, multiplied by returns of the tackle, ends, on one side, on the last inner pulley and on the other side on the last outer pulley, causing an unbalancing torque on the pulley-carrying axis, with the result of a lateral flexing of the cylinder stem, which increases proportionally to the extension of the stem itself.

Finally, hydraulic lifting systems known up to now have serious difficulties in carrying out small adjustments of the possible different length of the cables, which must be carried out inside the motorisation container which can even be more than 12 metres above ground. The positioning in height, above the door, of such a container requires, indeed, that at least one scaffolding must be mounted so as to be able to reach it.

Other drawbacks are represented by the difficulty of installation and adjustment of possible end stop microswitches, on the way up and down (given the need to securely fix the electrical cables to the centre of the container, to avoid them from ending up below the moving pulleys), by the production costs of the position stops (constructed with the cantilevered pin) and by the costs of attachment of the hydraulic cylinder (because it requires a welded support) and by the possible installation problems of the motorisation container (due to its bulkyness).

In the aforementioned requirements, the main purpose of the present invention is, therefore, that of indicating an improved hydraulic lifting sectional security door which avoids the aforementioned drawbacks and, in particular, that of indicating a sectional door which is strong and adaptable to any construction of the relative motorisation.

Another purpose of the invention is that of indicating an improved hydraulic lifting sectional security door which is efficient and reliable, even in the case in which there are errors, which are frequent in building, in the construction of the entry space and the room to be closed.

A further purpose of the invention is that of realising an improved hydraulic lifting sectional security door which is not expensive, with respect to conventional solutions, and which allows any type of adjustment and adjustment to be carried out simply and quickly.

Yet another purpose is that of allowing installers to buy motorisations which are adaptable at the time of installation, and thus making large savings with respect to the ordering of a piece to size for each door.

Such purposes are achieved by an improved hydraulic lifting sectional security door according to claim 1, to which we refer for the sake of brevity.

Other purposes and advantages of the present invention shall become clearer from the following description and from the attached drawings, provided as a non-limited example, in which:

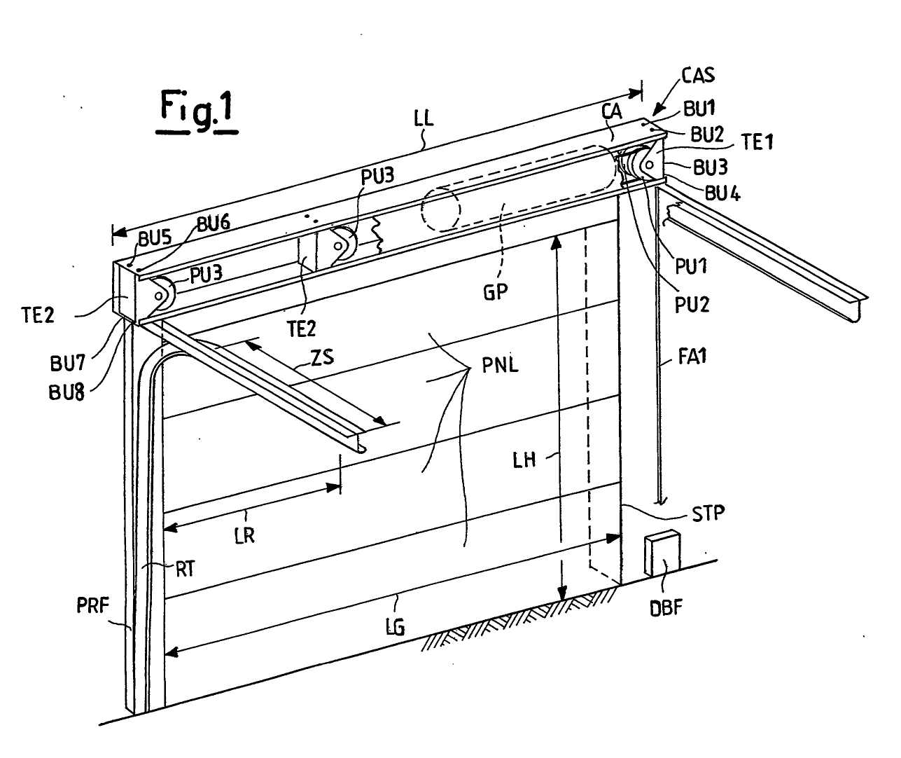

FIG. 1 is a perspective view of a hydraulic lifting sectional security door according to the present invention;

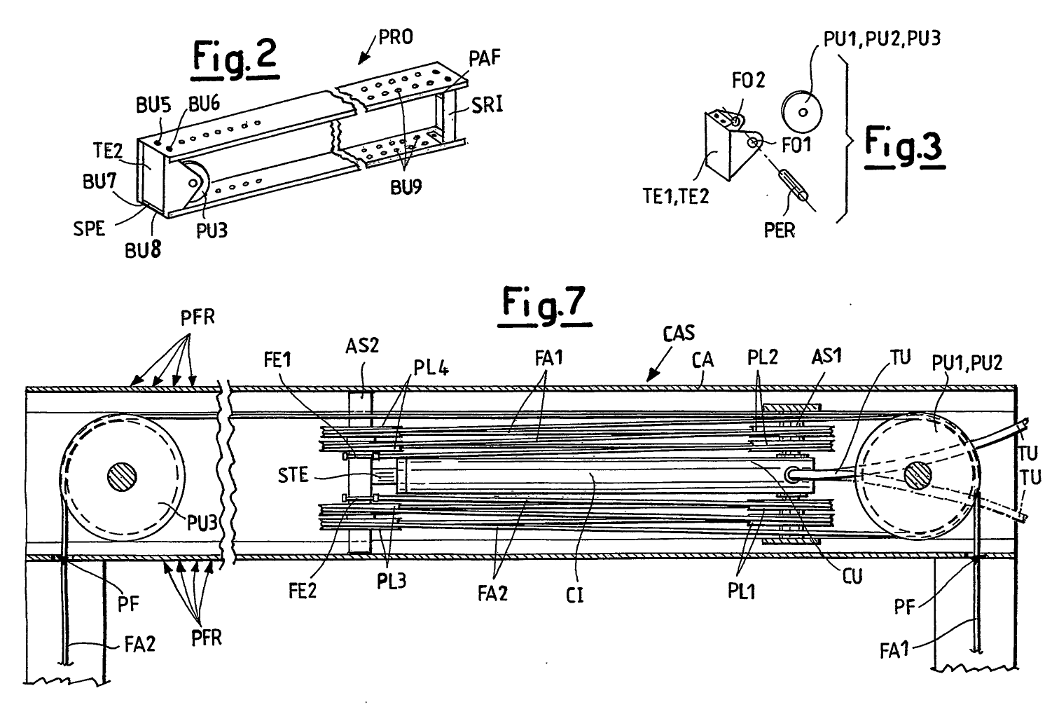

FIG. 2 shows an enlarged perspective view of an extension capable of being adjusted which can be applied to the container of the sectional door of FIG. 1;

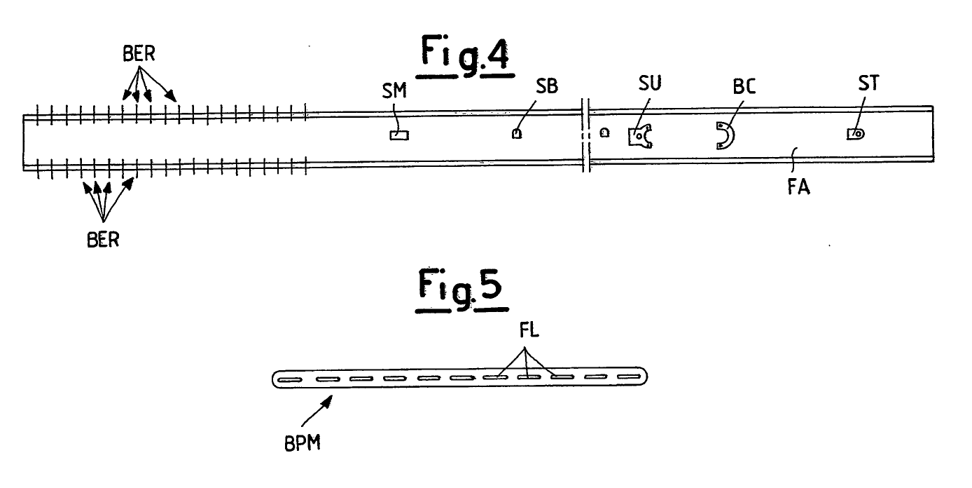

FIG. 3 shows an enlarged perspective view of a position stop of the motorisation container of the sectional door according to FIG. 1;

FIG. 4 is an enlarged plan view of an intermediate face of the motorisation container of the improved hydraulic lifting sectional security door according to the present invention;

FIG. 5 is an enlarged plan view of a bracket suitable for supporting microswitches for actuating the motorisation applied to the improved sectional door according to the invention;

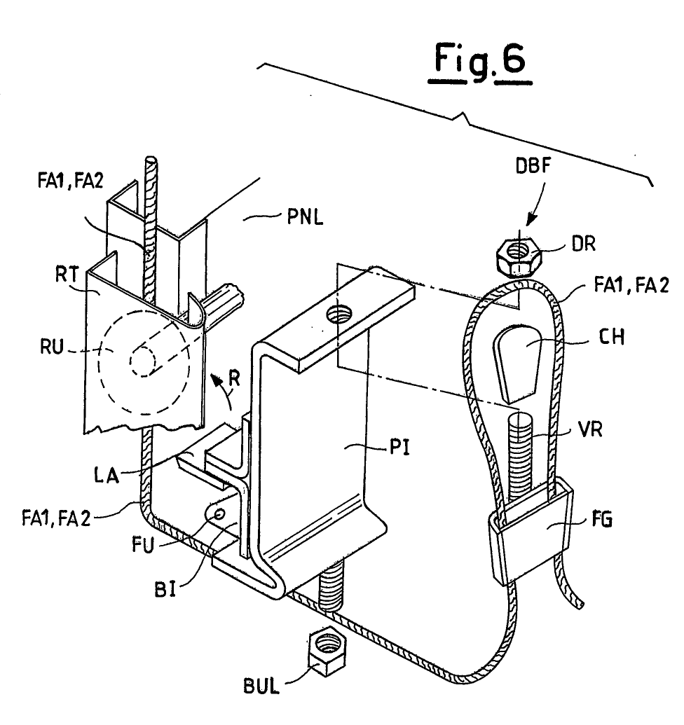

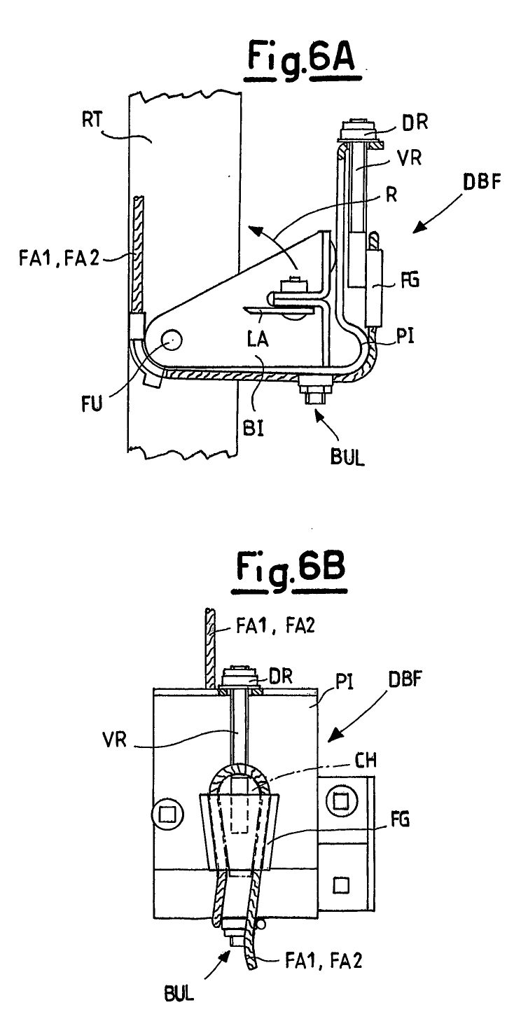

FIG. 6 shows an enlarged detail relative to a component of a safety device against the falling of the door (“parachute”) caused by the accidental breaking of the cables, also for adjusting the length of the cables;

FIG. 6A is a partial side and partial section view of the safety device according to FIG. 6, also for adjusting the length of the cables;

FIG. 6B is a partial front view of the safety device according to FIG. 6, also for adjusting the length of the cables;

FIG. 7 is a first enlarged partial front view of the improved hydraulic lifting sectional security door according to the present invention;

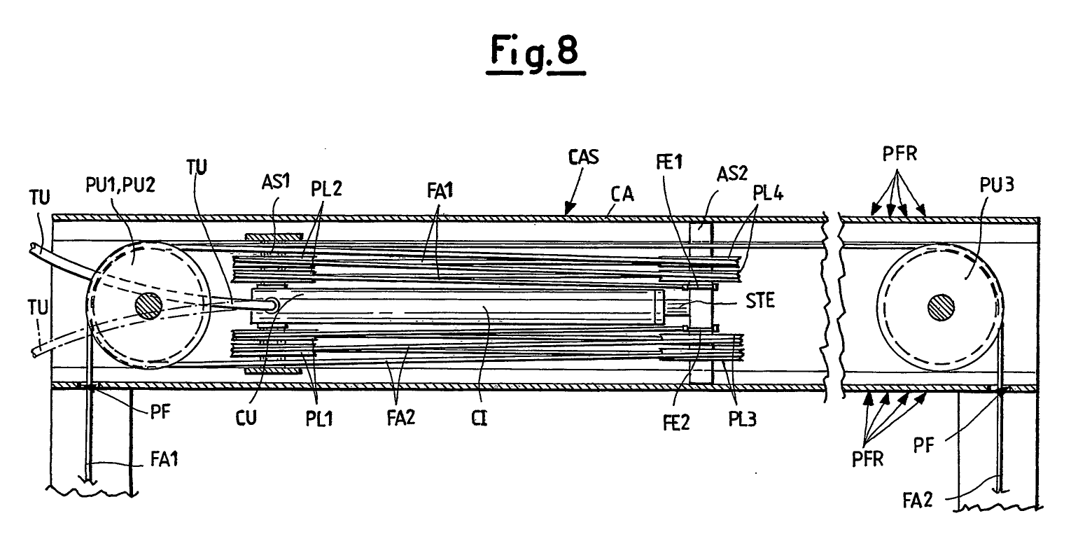

FIG. 8 is a second enlarged partial front view of the improved hydraulic lifting sectional security door according to the invention, in which the reversibility of the moving container of the sectional door is highlighted.

With reference to the figures mentioned, the improved sectional door according to the invention essentially comprises a pair of profiles PRF, associated with respective rails RT, which are arranged close to each frame STP of an entry space to a room having width LG and height LH, a single-piece panel or a series of panels PNL, articulated together through hinge bindings, and a group GP, inserted inside a motorisation container CAS generally arranged above the door, for lifting the panels PNL.

The panels PNL are also equipped on each side with wheels engaged with the rails RT, which guide the panels PNL in their open and close movement.

The profiles PRF, arranged at the front of the rails RT, are used for attachment to the wall and constitute abutment elements for the panels PNL of the sectional door.

The container CAS consists of a profile CA, preferably closed C-shaped and with horizontal size LL, preferably arranged with the open side facing the side opposite to the wall.

In cases of installation with a small lintel, when the container CAS is not placed above the door and against the wall, it is installed at the ceiling, at the end of the horizontal sliding zone of the door, schematically indicated with ZS in FIG. 1, generally with the open part facing downwards.

With particular reference to FIG. 1, it should be noted that at the sides of the container CAS two position stops TE1, TE2 are foreseen, formed from a simple sheet which is suitably bent and shaped, with a series of suitable bores.

The position stop TE1 (FIG. 3) has a through pin PER for the two holes FO1, FO2, suitably fixed with known means, such as Seger rings. Two pulleys PU1, PU2, preferably with a deep throat, are also journalled and fixed onto the axis of the pin PER through known means. The position stop TE2 has a pin like the position stop TE1, on which a pulley PU3, also preferably with a deep throat, is journalled and suitably fixed with known means.

The position stops TE1 and TE2 can possibly be inverted, changing the windings of the cables on the pulleys of the lifting group GP.

The aforementioned position stops TE1, TE2 are preferably constructed with a height such as to be able to be inserted inside the motorisation container CAS and are equipped, at the two bent upper and lower sides, with at least one hole per side, preferably formed in the direction of the length of the container CAS. In such a way, the position stops TE1, TE2 can be fixed to the container CAS by means, for example, of four bolts per side, respectively BU1, BU2, BU3, BU4, BU5, BU6, BU7, BU8 which enter into preferably round holes in the container CAS.

The bores of the position stops TE1, TE2 allow an adjustment of the distance between the position stops themselves.

Preferably, on the intermediate face FA of the container CAS (see, in particular, FIG. 4) one or more cylinder supports SU, one or more cylinder blocks BC, one or more tube supports ST, one or more microswitch supports SM and one or more supports SB for a microswitch-carrying bar BPM (FIG. 5) can be formed. The supports can even carry out many functions, like for example the cylinder support SU which also has a hole for supporting and passing a tube.

All of the aforementioned supports are preferably formed directly by the sheet constituting the container CAS, so as to avoid the additional cost of material, and are available at the exact size and at the time and place of assembly of the group or according to their needs.

The detachable pieces, like in particular the cylinder block BC, are left joined in their original position, preferably through the non-cutting of one or more small sectors of their cutting perimeters, and can easily be detached by hand. Moreover, the supports which are used are preferably bent at a right angle with respect to the bottom of the container CAS.

With particular reference to FIGS. 7 and 8, the container CAS contains a lifting group GP consisting of a hydraulic cylinder CI, equipped in its cylinder head CU with an axis AS1, on which at least one pulley PL1, PL2 per side rotate, fixed in position by known attachment systems.

The stem STE of the cylinder CI is equipped with another axis AS2, on which at least one pulley PL3, PL4 per side rotate, also arranged in position by means of known attachment systems.

On the axis AS1 or on the axis AS2 one or more locks FE1, FE2 are mounted, used for hooking the flexible steel cables FA1, FA2, for each side of the cylinder CI, preferably displaced towards and away from the cylinder CI.

The steel cables FA1, FA2, fixed on stops FE1, FE2, are passed alternatively in the throats of the pulleys PL1, PL2, PL3, PL4 journalled onto the axis AS1, AS2 opposite and on the original one, according to the known pulley system.

FIG. 7 shows, as an example, the stops FE1, FE2 mounted on the axis AS2, four pulleys PL1, PL2 journalled on the axis AS1 and four pulleys PL3, PL4 journalled on the axis AS2.

In the illustrated example, moreover, the cables FA1, FA2 are passed from the respective stop FE1, FE2 to the pulley PL1, PL2 of the opposite axis AS1, once more to the pulley PL3, PL4 of the original axis AS2 and once again to the pulley PL1, PL2 of the opposite axis AS1, for a total of five multiplications, before being sent onto the pulleys PU1, PU2.

It is clear that, besides the particular illustrated combination, all direct thrust or multiplication combinations which may be desired can be realised, inserting no pulley (1:1 ratio with the stroke of the cylinder CI), two multiples (starting from the axis AS1 and rotating on one pulley per side on the axis AS2), five multiples (in the example case illustrated in FIG. 7) or other multiples, inside the container CAS.

According to the prior art, the cables FA1, FA2 start one next to the cylinder CI and one on the outside with respect to the cylinder CI, to end, after the multiplications, at the pulleys PU1, PU2, passing one outisde (above) the pulley pack PL2 to be deviated by the pulley PU1 at a right angle downwards, and the other between the pulleys PL1, PL2, to then be deviated by 180° by the pulley PU2 to be sent back, sliding above the whole pack, up to the pulley PU3, which deviates it at a right angle downwards, from the opposite side.

Such a construction, however, forces right an left containers CAS to be constructed, due to the impossibility of inverting the container group CAS by 180°, and of thus obtaining the desired left or right exit of the hydraulic supply tube TU of the cylinder CI. The construction of the container CAS must therefore be realised just to size, with obvious substantial limitations with regard to the distribution and commercialisation thereof.

Moreover, this type of conventional construction causes, in heavier doors, a different torque deriving from the unbalanced departure and arrival of the two cables FA1, FA2, with the consequent lateral flexing of the stem STE of the cylinder CI.

The geometry of the exit of the cables FA1, FA2, joined at a primary diameter of at least 20 times the diameter of the cables FA1, FA2, makes it impossible to have a greater compression of the size, with the impossibility of assembling the system in some particular cases of a small lintel.

According to the present invention, on the other hand, the cables FA1, FA2 start from stops FE1, FE2, preferably arranged alongside the cylinder CI, and their exit in the direction of the pulleys PU1, PU2, takes place in a balanced manner, on the two outer sides of the pulley PL1, PL2. This allows the container CAS to be rotated by 180°, taking the hydraulic cylinder and the exit of the hydraulic tube TU, where most desired, to the right or to the left, simply varying the cable FA1, FA2, which must exit at a right angle downwards on the first pulley, PU1 or PU2, and taking one or the other cable FA1, FA2, after having been deviated by 180° on the pulley PU1, PU2, to the pulley PU3, which deviates it at a right angle downwards.

The possible embodiments are clearly shown in the details of FIGS. 7 and 8.

For the exit of the cables FA1, FA2 from the container CAS towards the door to be lifted, after their deviation on the pulleys PU1 or PU2, and PU3, suitable holes PF are foreseen in the container CAS.

With this solution a reversible container CAS and a thrust which is always balanced is obtained, with the same torque on the two sides of the axis AS2 of the stem STE, eliminating the lateral stress thereof.

To make the application of the motorisation container CAS elastic in space width LG, with lower measurements with respect to the standard width of the container CAS itself, at least on the opposite side to the one where the hydraulic cylinder CI is installed, at least one series of holes or pre-holes PFR can be foreseen on at least one of the sides of the profile CA, of a size suitable for the exit of the cable FA1, FA2, and the repitition with the same pitch of the holes suitable for receiving the bolts BU5, BU6, BU7, BU8.

The position stop TE2, which carries the pulley PU3, can thus be displaced towards the inside of the container CAS, by one or more pitches, so as to respond to the dimensional requirements.

As already stated, the position stops TE1 and TE2 preferably have the holes corresponding to the bolts BU1, BU2, BU3, BU4, BU5, BU6, BU7 and BU8 present on the container CAS, in an elongated rhombus shape.

Thus, for example, the possibility of adjusting the exit downwards of the two cables FA1, FA2 is obtained, with a pitch of just 10 mm. Indeed, the two position stops TE1, TE2, can be adjustables for 20 mm and at least the position stop TE2 can be displaced with a pitch of 50 mm.

Obviously, if the position stop TE2 is displaced inwards, the hole PFR necessary for the exit of the cable FA2 shall be open, said cable, also for aesthetic reasons, preferably being only precut on all of its diameter, minus two or three small sectors.

The container CAS (FIG. 4) is preferably equipped on the front with at least one series of holes BER with a constant pitch, for example 50 mm, which give the installer the exact cutting measurement if the excess part of the container CAS, after having adjusted the position stop TES 2 inwards, causes difficulties.

In order to make the specific application of the motorisation container CAS adaptable to sizes greater than its length (for example for a width which can be adjusted indicated with LR in FIG. 1), it is also foreseen to use an extension door PRO (FIG. 2), with a slightly larger section than that of the container CAS, such as to be able to telescopically go on top of said container.

An end of the extension PRO is equipped with the same attachment holes of the position stop TE2 to the container CAS and, given the greater section size of the extension PRO with respect to the container CAS, a small profile SPE, preferably with an angular shape and 5 mm thick, is foreseen which is placed between the position stop TE2 and the extension PRO to compensate the heights.

The extension PRO is preferably equipped with a series of holes BU9 with a constant pitch, for example 50 mm, corresponding to the attachment holes of position stop TE2 to the container CAS, so as to be able to be fixed telescopically to the container CAS with bolts, at the desired width LG.

The extension PRO also has top bores BU5, BU6, BU7, BU8, to which the mirror-like position stop TE2 is applied, so as to be reversible.

Moreover, in cases in which just one extension portion PRO is necessary, the profile PRO can be cut and, precisely thanks to the fact that the two position stops of the profile have mirror-like holes, the portion of the container CAS not used can be recovered and used for another extension.

The joining of the extension PRO to the container CAS preferably also foresees the insertion of at least one reinforcement bracket SRI, which essentially keeps the open side of the container CAS and of the extension PRO joined, at the joining point, which can constitute a critical point, in cases in which the extension PRO is applied in a very extended position with respect to the container CAS.

At the bracket SRI, a sliding block PAF made from anti-friction material, e.g. PVC, can be mounted, which limits the lowering of the cable FA1 or FA2 in cases of maximum extension of the container CAS and extension PRO group, which could happen in the case of release of the cable FA1, FA2 with the door totally closed.

The need to be able to rotate the container CAS with the cylinder CI by 180° and the exit of the hydraulic tube TU to the right or to the left derives from the need to lower with the hydraulic tube TU up to the electrohydraulic motor, which is generally positioned at the wall, at a man's height, to the side of the door.

There are cases in which there is not space for the application of such a motor to the right or to the left and there are other cases in which two hydraulic doors are applied to the same motor and, consequently, it is necessary that the hydraulic exits of two contiguous doors lower at the same place, one to the right and one to the left.

In the embodiment described in the present invention it is sufficient just to invert the two lifting cables FA1, FA2 and to mount the container CAS with the hydraulic cylinder CI from the opposite side, with respect to its original position, without having to make any other provisions.

Moreover, in its configuration for service with command in the presence of a person, the motorisation consisting of the container CAS, with the cylinder CI moved by hydraulic force produced by a suitable system, there is no need for another safety system apart from the maximum pressure valve, provided it is ensured that the end stop of the hydraulic cylinder CI corresponds to the end stop of the open door. Obviously, the motorisation can also be used limiting its stroke with a limit switch. The use of command automations of the door then requires the application of limit microswitches with the cylinder CI extended and/or with the cylinder CI partially or totally retracted, operated by known cams.

For such a requirement, on the intermediate face FA of the container CAS (FIG. 4) one or more tube supports ST are foreseen which, raised at a right angle with respect to the bottom of the container CAS, allow the insertion of a plastic tube for electrical conductors, with the certainty that the cablings will always remain perfectly protected in said tube, without risking ending up in the clearances of the pulleys.

On the intermediate face FA of the container CAS (see FIG. 4) one or more supports SM can also be foreseen for the direct application of microswitches, in particular in the fixed position corresponding to the end stop of the hydraulic cylinder CI. Still on the intermediate face FA of the container CAS one or more supports SB are also formed for one or more microswitch-carrying bars BPM.

In particular, the bar BPM is equipped with rhombus-shaped holes FL (FIG. 5), the pitch of which allows the microswitch to be fixed in whatever position, displacing the bar BPM itself forwards or backwards with respect to the bar-holder SB, should the attachment screws of the microswitch coincide with the joining points between the rhombus-shaped holes FL of the bar BPM.

Finally, the containers CAS and the extensions PRO are preferably equipped with a cover, not illustrated in the figures.

The adjustment of the length of the two cables FA1, FA2, which lift the door generally lifting it from the lower panel, can take place inside the container CAS of the motorisation, with the application of known screw adjusting systems, like, for example, through the known adjustment system for motorcycle brakes.

According to the invention, such an adjustment procedure can furthermore be applied to the known “parachute” of sectional doors, with substantial benefit.

In practice, the lifting cables FA1, FA2 are generally thrusted below the base panel of the door, in a suitable throat (FIG. 6A), and are deviated up to a bolt BUL, to which they are fixed. The bolt is also connected to a pivoting plate BI which, in the case of breakage of the cable FA1, FA2, rotates with radius R on the fulcrum FU and engages on the rail RT, blocking the lowering of the door (like in the case of the “parachute”).

According to the present invention, to the bolt BUL usually used to fix the end of the cable FA1, FA2 a device DBF is applied consisting of a bearer plate PI, which preferably ends with a square shape in the upper part and on said square it has a hole, and of a steel container with a trapezoidal throat FG equipped with a screw VR, in the throat FG of which the lifting cable FA1, FA2 is passed from the bottom upwards which, after having been wound around a wedge-shaped key CH, is passed back inside the aforementioned container FG, so that it can spontaneously lock by throttling (see FIGS. 6A and 6B).

In particular, in normal operating conditions, the lifting cable FA1 or FA2, throttled by the action of the key CH inside the container FG (FIG. 6), maintains the relative biscuit BI detached from the rail RT. When the cable FA1 or FA2 breaks, the biscuit BI rotates like a spring along the direction defined by the arrow R of FIG. 6A, with a pin on the fulcrum FU, such that the blade LA engages against the rail RT blocking the lowering of the panels PNL. It is also possible to carry out a fine adjustment of the device DBF acting upon the adjustment nut DR of the suspension screw VR of the trapezoidal container FG.

The use of such a device allows all adjustments of the length of the cables to be carried out immediately, at ground level, without having to go up to heights which may even be substantial, sometimes greater than 12 metres.

The emergency lifting manouevre of such hydraulic doors can be carried out manually, in the case of a lack of electrical energy at the motor, by means of a manual pump, or else it can be carried out through the use of an electric drill, operated by batteries or compressed air, the drill bit of which is actuated in engagement with the shaft of the suitably arranged motor.

Indeed, the axis of the electric motor, which is opposite the side connected to the hydraulic pump of the electrohydraulic power unit (or the geared motor, should the system have one), is generally provided for the purpose and is free, since on that side a cooling fan is generally foreseen, which is usually fixed radially outside of such an axis.

According to an aspect of the present invention, it can therefore be foreseen to arrange at the end of this axis an attachment seat for a drill, which can be operated by compressed air, batteries or electricity, suitable for making the motor spin, so as to actuate the mechanism of the power unit also in the case of a lack of a power supply.

The connection seat for the drill bit can, as a preferred but not limiting example, be a cut or protruding hexagon, realised directly on the axis of the motor. Alternatively, a tapping can be created on the aforementioned motor axis, on which it is thus possible to screw in a screw equipped with a head which can create the connection with the moving drill bit, which shall, for example, preferably have a hexagonal bit.

From the description which has been made the characteristics of the improved hydraulic lifting sectional security door, object of the present invention, are clear, just as the advantages are also clear.

It is clear, however, that numerous other variants can be brought to the improved sectional security door in question, without for this reason departing from the novelty principles inherent to the inventive idea, just as it is clear that, in the practical embodiment of the invention, the materials, the shapes and the sizes of the illustrated details can be whatever according to the requirements and they can be replaced by others which are technically equivalent.

1. Improved hydraulic lifting sectional security door, capable of being installed at an entry space to a room, comprising a pair of profiles (PRF), associated with respective rails (RT), arranged near to each frame (STP) of the entry space, a single panel or a series of panels (PNL) articulated together and a device or group (GP) for lifting the panels (PNL), which includes a hydraulic cylinder (CI), to which lifting cables (FA1, FA2) are fixed, characterised in that said lifting cables (FA1, FA2) start from stops (FE1, FE2) foreseen in a substantially central position with respect to said cylinder (CI) ad go, on the way out, towards return pulleys (PU1, PU2) in a balanced manner, such that said container (CAS) can be installed with the hydraulic cylinder (CI) in a right or left position with respect to the entry space, according to the user's desires and requirements.

2. Improved hydraulic lifting sectional security door according to claim 1, characterised in that said lifting device or group (GP) is inserted inside a motorisation container (CAS), comprising a shaped profile (CA) closed at the side by position stops (TE1, TE2) fixed to said container (CAS), which are invertible and are formed from a suitably bent and shaped sheet with a series of bores.

3. Improved hydraulic lifting sectional security door according to claim 2, characterised in that each position stop (TE1, TE2) has at least one pin (PER), on which at least one of said return pulleys (PU1, PU2, PU3) is journalled.

4. Improved hydraulic lifting sectional security door according to claim 2, characterised in that said container (CAS) foreseen at least one intermediate face (FA), on which at least one cylinder support (SU), at least one cylinder block (BC), at least one tube support (ST), at least one microswitch support (SM) ad at least one support (SB) for at least one microswitch-carrying bar (BPM) can be forced, said supports preferably being formed directly from the sheet constituting the container (CAS) to avoid additional material costs.

5. Improved hydraulic lifting sectional security door according to claim 1, characterised in that said hydraulic cylinder (CI) is connected to a plurality of lifting pulleys (PL1, PL2, PL3, PL4) and, in particular, has a stem (STE) equipped with at least one first axis (AS1), on which at least one first pair (PL1, PL2) of said lifting pulleys (PL1, PL2, PL3, PL4) rotates, and with at least one second axis (AS2), on which at least one second pair (PL3, PL4) of said lifting pulleys (PL1, PL2, PL3, PL4) rotates, said stops or locks (FE1, FE2) used for the hooking of the lifting cables (FA1, FA2) being mounted on said first (AS1) or second (AS2) axis, for each side of the cylinder (CI).

6. Improved hydraulic lifting sectional security door according to claim 5, characterised in that said Lifting cables (FA1, FA2) pass, alternatively, on the lifting pulleys (PL1, PL2, PL3, PL4) journalled on to said first (AS1) and second (AS2) axis, as tackle, before being sent to said return pulleys (PU1 PU2, PU3), or else they go directly from said second axis (AS2) to said return pulleys (PU1, PU2, PU3).

7. Improved hydraulic lifting Sectional security door according to claim 6, characterised in that said lifting cables (FA1, FA2) start from stops (FE1, FE2) arranged in a position next to said cylinder (CI), and their exit in the direction of the return pulleys (PU1, PU2) takes place on the outer sides of said first pair (PL1, PL2) of lifting pulleys (PL1, PL2, PL3, PL4), so as to be able to rotate said container (CAS) and to take said cylinder (CI) and the exit of the hydraulic tube (TU) to the right or to the left of the entry space simply varying a first cable (FA1, FA2) leaving at a right angle downwards on a first return pulley (PU1, PU2) and taking a sed cable (FA1, FA2), after having been deviated by 180° on a second return pulley (PU2), to a third return pulley (PU3), which deviates it at a right angle downwards.

8. Improved hydraulic lifting sectional security door according to claim 2, characterised in that said motorisation container (CAS) can foresee a series of pre-holes (PFR), at least on the side opposite the one where said hydraulic cylinder (CI) is installed, for the exit of said lifting cables (FA1, FA2), in order to suitably displace at least one first position stop (TE2).

9. Improved hydraulic lifting sectional security or according to claim 8, characterised in that said container (CAS) foresees the installation of at least one portion of a further container extension (PRO), which allows it to be made adaptable in door width, for width measurements (LR) which can be adjusted, said extension (PRO) being equipped with a series of top bores and holes corresponding to the attachment holes of said first position stop (TE2) to the container (CAS).

10. Improved hydraulic lifting sectional security door according to clan 8, characterised in that at least one end of said extension (PRO) is equipped with attachment holes of said first position stop (TE2) to the container (CAS) and preferably at least one small profile (SPE), preferably angular-shaped, is placed between said first position stop(TE2) and said extension (PRO) to compensate the heights, said top bores, in a preferred version, being foreseen for the application of said first mirror-like position stop (TE2), so as to be reversible.

11. Improved hydraulic lifting sectional security door according to claim 10, characterised in that said extension (PRO) is joined to said container (CAS) by means of at least one reinforcement bracket (SRI), which essentially keeps the open side of the container (CAS) and of the extension (PRO) joined, at the joining point.

12. Improved hydraulic lifting sectional security door according to claim 10, characterised in that, preferably at said bracket (SRI), at least one sliding block (PAF), preferably made from anti-friction material, is mounted, which limits the lowering of at least one of said lifting cables (FA1, FA2) in cases of maximum extension of the container (CAS) and extension (PRO) group.

13. Improved hydraulic lifting sectional security door according to claim 9, characterised in that said container (CAS) and said extension (PRO) are preferably equipped with at least one cover.

14. Improved hydraulic lifting sectional security door according to claim 1, characterised in that said lifting cables (FA1, FA2) can be adjusted through screw adjustment systems.

15. Improved hydraulic lifting sectional security door according to claim 14, characterised in that said lifting cables (FA1, A2) are thrusted below a base panel of the door, preferably in a suitable throat, and deviated up to a container (FG), in which they are fixed, said container being connected to a plate (PI), which in turn is connected to a biscuit element (BI) which, in the case of breakage of at least one cable (FA1, FA2), rotates and engages on the rail (RT), blocking the lowering of the door.

16. Improved hydraulic lifting sectional security door according to claim 15, characterized in that to said biscuit (BI) a device (DBF) is applied comprising a bearer plate (PI) and a container with a throat (FG), in which said lifting cables (FA1, FA2) are passed which, after having been wound around a preferably trapezoidal key (CH), is passed back inside said container (FG), so that it can spontaneously lock by throttling, through the action of the key (CH) inside said container (FG), said adjustment being realised by action on a suspension screw (VR) of said container (FG).

17. Improved hydraulic lifting sectional security door according to claim 1, characterised in that it is possible to carry out an emergency lifting manoeuvre of said door, in the case of a lack of electrical energy at the motor, by means of a manual pump, or through the use of an electric drill, powered by batteries or compressed air, the bit of which is actuated in engagement with the suitably arranged drive shaft, since the axis of the electric motor, which is opposite the side connected to a hydraulic pump or to a geared motor of an electrohydraulic power unit, is generally uncovered and is free for the connection of said drill.
